(19) United States
(12) Patent Application Publication
(10) Pub. No.: US 2009/0101590 A1
(43) Pub. Date: Apr. 23, 2009

(54) Wastewater treatment method and apparatus

(76) Inventor: Michael Ryan Stanley, Clarenville (CA)

Correspondence Address: HARDING, EARLEY, FOLLMER & FRAILEY, 86 THE COMMONS AT VALLEY FORGE, 1288 VALLEY FORGE ROAD, P. O. BOX 750, VALLEY FORGE, PA, 19482-0750, US

(21) Appl. No.: 12/215,431

(22) Filed: Jun. 27, 2008

(30) Foreign Application Priority Data
Oct. 19, 2007 (CA) 2607080

(51) Int. Cl. C02F 1/00

(52) U.S. Cl. 210/747; 210/170.08

(57) ABSTRACT

A method for treating wastewater, comprising distributing the wastewater into a disposal trench, percolating the wastewater through primary filtration treatment material positioned within the trench, transferring the wastewater into a storage area filled with storage material, percolating the wastewater through secondary treatment material, transferring the wastewater away from the secondary treatment material and into the environment, wherein the secondary treatment material is positioned at a distance horizontally from the trench and a device for treating wastewater, comprising at least one disposal trench adapted to receive, transport and percolate wastewater therefrom, primary filtration treatment material positioned within the trench and adapted to receive and percolate wastewater therethrough, a storage area filled with storage material, secondary treatment material positioned at a distance horizontally from the trench adapted to receive and percolate wastewater therethrough, means for transferring the wastewater away from the secondary treatment material and into the environment.

### FIELD OF THE INVENTION

The present invention relates to wastewater treatment, and more particularly relates to wastewater treatment methods and an apparatus in which wastewater is stored, treated and disposed of after treatment into the surrounding environment.

### BACKGROUND OF THE INVENTION

Conventionally, wastewater treatment and disposal may include the utilization of a field (hereinafter sometimes referred to as a “wastewater field”) into which the wastewater is disposed, by means of an absorption/percolation/leaching processes, using, for example, trenches into which perforated pipes or tiles (hereinafter “perforated pipes”) are positioned, the wastewater flowing through the perforated pipes and into the ground, and thereafter the wastewater is subjected to a process known as evapotranspiration (a combination of evaporation, whereby the wastewater moves through the soil and is evaporated into the air above the soil, and transpiration, whereby the wastewater moves through the soil, the wastewater thereafter transpiring into the air through the leaves of the plants growing thereon on that soil). Although evapotranspiration provides certain benefits in the context of wastewater treatment, conventional evapotranspiration fields limit the depth of the field and may have a negative impact on the field's overall storage capacity, and surface area requirements.

Advantageously, the apparatus and method of the present invention either entirely removes the evapotranspiration portion of the wastewater treatment field, or alternatively, positions the evapotranspiration portion of the wastewater treatment field remotely from the trenches in which the perforated pipes are positioned. This removal or repositioning of the evapotranspiration portion of the wastewater treatment field can significantly increase the storage capacity of the wastewater treatment field, and/or can significantly reduce the wastewater treatment field's required surface area, making it possible to install a larger scale wastewater treatment field at a given location. It also permits the trenches in which the perforated pipes are positioned to be located in areas where evapotranspiration would otherwise not be affective.

### SUMMARY OF THE INVENTION

Accordingly, one object of the present invention is to provide a wastewater treatment field with increased wastewater storage and handling capacity.

Accordingly, another object of the present invention is to provide a wastewater treatment field with a reduced surface area and/or reduced trench length.

Accordingly, another object of the present invention is to provide a wastewater treatment field in which the trenches in which the perforated pipes are positioned are located in areas where evapotranspiration would otherwise not be affective.

According to one aspect of the present invention, there is provided a method for treating wastewater, the method comprising the steps of distributing the wastewater into a disposal trench; percolating the wastewater through primary filtration treatment material positioned within the trench; transferring the wastewater into a storage area filled with storage material; percolating the wastewater through secondary treatment material; transferring the wastewater away from the secondary treatment material and into the environment; wherein the secondary treatment material is positioned at a distance horizontally from the trench.

According to another aspect of the present invention, there is provided a device for treating wastewater, comprising, at least one disposal trench adapted to receive, transport and percolate wastewater therefrom; primary filtration treatment material positioned within the trench and adapted to receive and percolate wastewater therethrough; a storage area filled with storage material adapted to receive and store wastewater; secondary treatment material positioned at a distance horizontally from the trench adapted to receive and percolate wastewater therethrough; means for transferring the wastewater away from the secondary treatment material and into the environment.

The advantage of the present invention is that it provides a wastewater treatment field with increased wastewater storage and handling capacity.

Another advantage of the present invention is that it provides a wastewater treatment field with a reduced surface area and/or reduced trench length.

Another advantage of the present invention is that it provides a wastewater treatment field in which the trenches in which the perforated pipes are positioned are located in areas where evapotranspiration would otherwise not be affective.

### BRIEF DESCRIPTION OF THE DRAWINGS

A preferred embodiment of the present invention is described below with reference to the accompanying drawings, in which:

FIG. 1 is a cross-sectional view of a previously known (prior art) trench in a wastewater field;

FIG. 2 is a vertical cross-section through the settling chamber and distribution box and portions of the wastewater field;

FIG. 3 is an enlarged view of a portion of the vertical cross-section of FIG. 2;

FIG. 4 is a cross-sectional view of two trenches in a wastewater field of one embodiment of the present invention;

FIG. 5 is an enlarged view of a portion of the vertical cross-section of FIG. 4;

FIG. 6 is a cross-sectional view from above of a wastewater field of one embodiment of the present invention;

FIG. 7 is an enlarged view of a portion of the cross-section of FIG. 6;

FIG. 8A is a cross-sectional view of an alternative embodiment of the wastewater field of the present invention;

FIG. 8B is an enlarged view of a portion of the vertical cross-section of FIG. 8A;

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

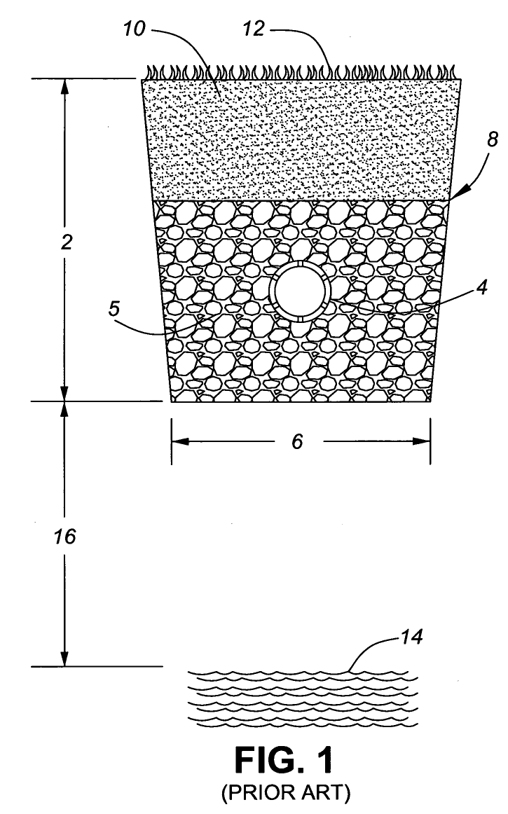

As illustrated in FIG. 1, the conventional (prior art) trench system used for wastewater may utilize a trench typically of a depth of between 24 and 36 inches and typically being at the least 18 inches wide at the bottom 6, the wastewater passing through a perforated pipe 4, typically surrounded by a bed 5 of 0.75 inch to 2.5 inch sized washed stone, the perforated pipe 4 typically being at least 6 inches above the bottom 6 of the trench, and the bed 5 of washed stone typically covering the perforated disposal pipe 4 by a minimum of 2 inches. A layer of untreated building material 8 or like material is positioned on top of the bed 5 of washed stone, and thereafter a bed of backfill 10, typically between 12 and 23 inches in thickness is applied on top of the layer of untreated building material 8, grass 12 or other plant life typically being planted on top of the backfill 10. Typically, the bottom of the trench is a least 3.25 feet above any bedrock, impervious strata, or groundwater 14.

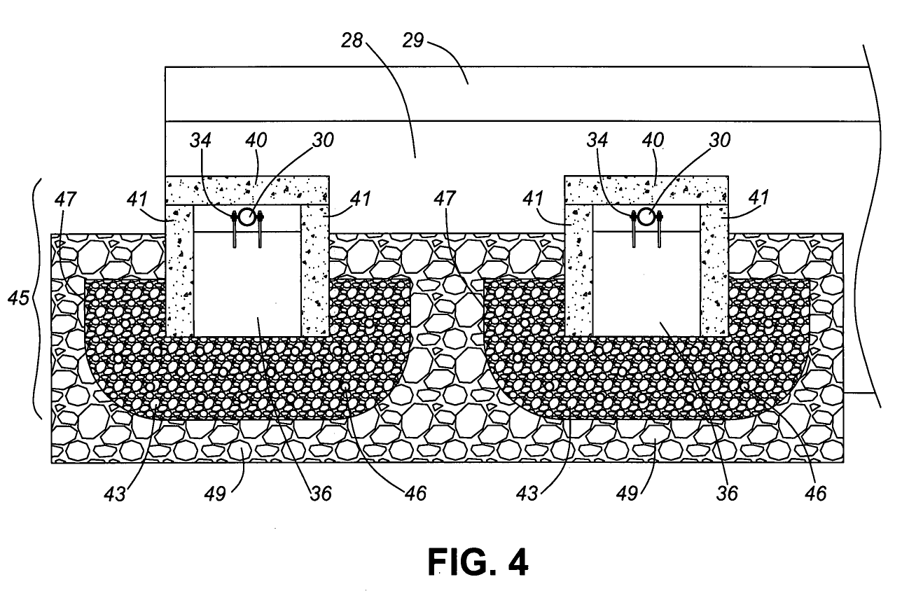

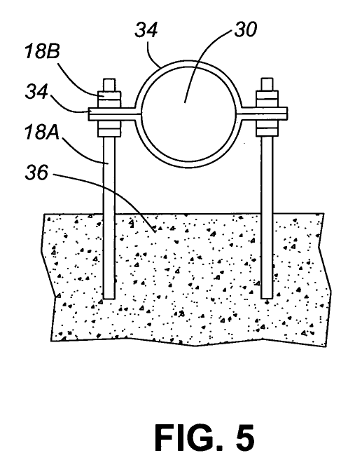

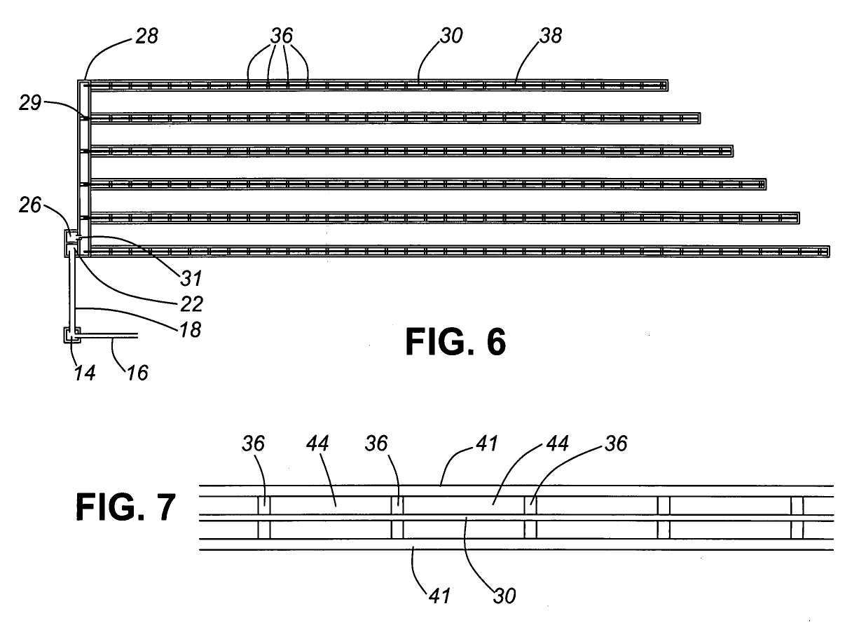

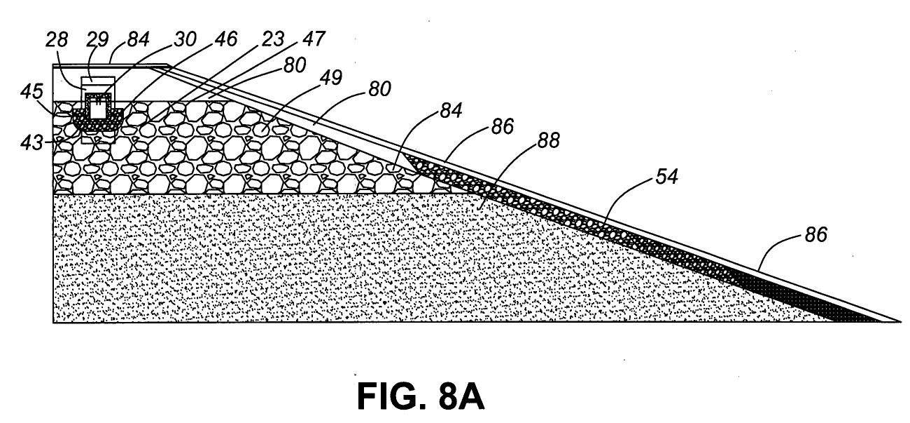

In the trench 45 or pit system (hereinafter collectively referred to as a “trench”) used in the preferred embodiment of the present invention, as illustrated in FIG. 4, a perforated pipe 30 is supported on and secured by height adjustable perforated pipe supports 34, which are preferably made of stainless steel or other material known to a person skilled in the art, which height adjustable perforated pipe supports 34, as illustrated in FIG. 5 are preferably attached by way of nuts 18B and bolts 18A, which bolts 18A are preferably anchored or otherwise securely fastened to transverse concrete base supports 36 which are positioned intermittently along a channel 38 as illustrated in FIGS. 6 and 7, the height adjustable perforated pipe supports 34 support the perforated pipes 30 and are height adjustable, to allow, during the construction of the trench system, for the perforated pipes 30 to be gently downwardly sloping (away from the distribution box 28 as more fully described herein) so that the gravity draws the wastewater through the perforated pipes 30 within the trench and away from the distribution box 28.

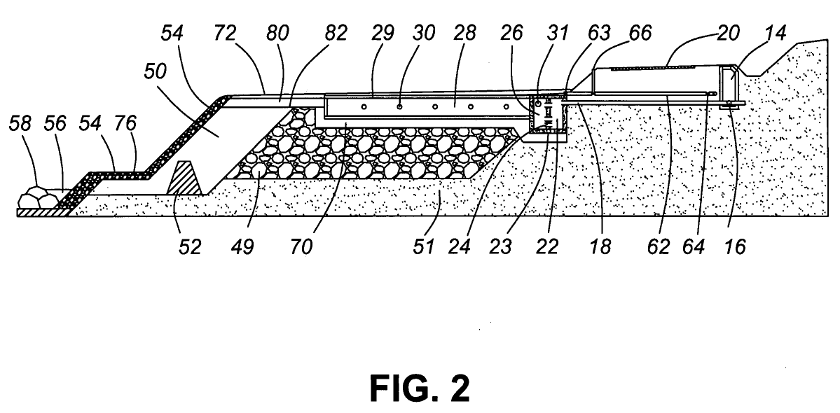

As illustrated in FIG. 4, in the preferred embodiment of the present invention, the channel 38 has concrete vertical walls 41 and a concrete removable cover 40, transverse concrete base supports 36 intermittently positioned within the channel 38 forming a series of chambers 44 along the length of the channel 38 as illustrated in FIGS. 6 and 7 into which chambers 44 wastewater flows from the perforated pipes 30 positioned therewithin, which wastewater thereafter flows from the chambers 44 and percolates into and through a heavy biological mat active within the primary filtration treatment material 43 (preferably rock or other material known to a person skilled in the art, having a flow rate of preferably 4-12), and thereafter preferably through a strong, durable and water permeable geo-textile fabric 47 surrounding and containing the primary filtration treatment material 43, the now partially treated wastewater thereafter entering the storage material 49 (which is preferably large rocks with lots voids or fillable space therebetween) positioned therebeneath as illustrated in FIG. 2, it being understood that while wastewater is within the storage material 49, the treatment of the wastewater is ongoing. In one embodiment of the present invention, as illustrated in FIG. 4, primary injection pipes 46, connected to, for example, a surface connection pipe (not shown) may be used to inject dosing chemicals or water under pressure into the primary filtration material 43 to thereby breakup, loosen or dissolve any biological material unduly blocking the flow of wastewater through the primary filtration material 43.

In one embodiment of the present invention, as illustrated in FIG. 2, as the wastewater enters into the storage material 49, it is pulled downwardly by gravity and is dispersed within the storage material 49 before reaching the previously existing or impervious material 88. Thereafter, the wastewater flows through the secondary treatment material 50 (preferably with a percolation rate of between 5 to 15 minutes per inch), and thereafter through a layer of gravel 54, through a purpose-constructed or engineered wetland 56, the vegetation (not shown) in which is fed by the treated wastewater, the treated wastewater preferably flowing through armour rock 58 (to protect the shore against ice from the purpose-constructed or engineered wetland 56 during the winter) and thereafter discharged into an estuary (not shown). In one embodiment of the present invention, an impervious-to-water flow block 60 may also be used to force the treated wastewater through the purpose-constructed or engineered wetland 56. In one embodiment of the present invention, the top of the field 72 (preferably made of Class-A stone) sheds the majority of the surface water from the field (the Class-A stone will preferably not extensively impair the passage of oxygen into the interior of the field) the surface water thereafter preferably flowing through the gravel 54 and into the purpose-constructed or engineered wetland 56 area. In an alternative embodiment of the present invention, as illustrated in FIG. 2, a preferably flat surface 76 is provided in the gravel 54 which may provide a work platform for workers or equipment for the purposes of maintaining the gravel bed 54, the shore of the purpose-constructed or engineered wetland 56 area, and if necessary, to provide access to the secondary treatment material 50.

In one embodiment of the present invention, as illustrated in FIG. 2, a secondary top 80 is provided (preferably made of fine particulate material of a type known to a person skilled in the art), which is separated from the storage material 49 by way of a geo-textile fabric 82, which geotextile fabric 82 protects the storage material 49 from receiving fine particles from the top 72 (grass or other surface covering) or secondary top 80. In this embodiment of the invention, the secondary top 80 aids in the dispersion of surface water and provides for an efficient placement of the top 72.

In one embodiment of the present invention, as illustrated in FIG. 2, the distribution box 28, (with a lid 29 thereon), and a settling chamber 23 (each preferably made of poured concrete or other material known to a person skilled in the art) are positioned upon a preferably gravel foundation bedding 70. As illustrated in FIG. 2, in one embodiment of the present invention, a semi-impervious flow restricter 52 may be positioned within the secondary treatment material 50, as a result of which more wastewater will be retained for storage within the storage material 49 before entering the secondary treatment material 50, and as a result of which wastewater may be forced closer to the surface of the secondary treatment material 50 to benefit from evapotranspiration and increased oxygen levels.

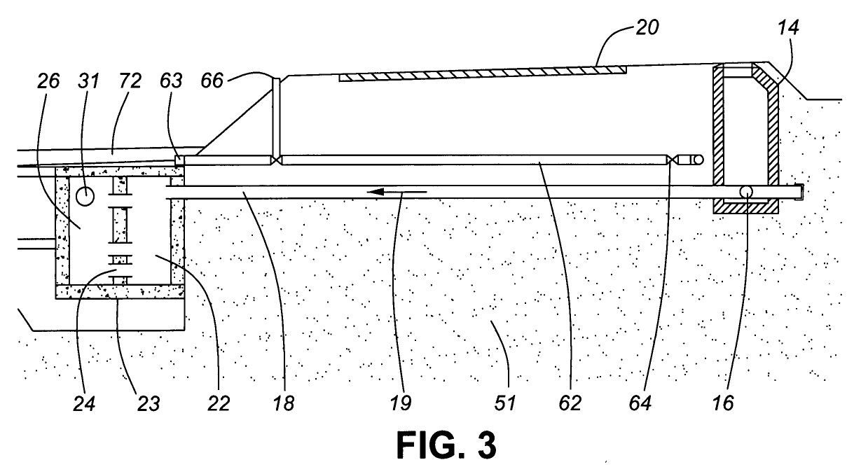

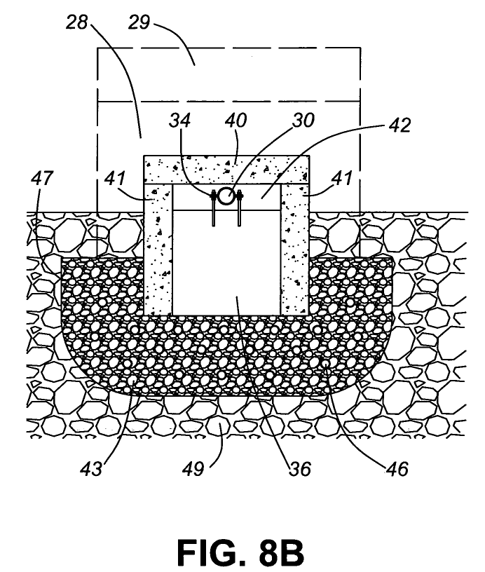

In one embodiment of the present invention, as illustrated in FIGS. 2 and 3, a air or water line 62 with an above-ground connection point 66 fitted with a non-return valve 64 (the non-return valve to stop water from flowing back into the system) and a shutoff valve/riser assembly 66 (#27) may be used the purposes of conducting operations and maintenance, by supplying air or water or other liquids through the primary injection pipes 46, which, in one embodiment of the present invention, as illustrated in FIGS. 4 and 8B, are positioned within the primary filtration treatment material in the trench, which when supplied with water or other liquids, will supply water or other liquids into the primary filtration treatment material to thereby clean up the primary treatment material (rock) in the trench 45. In an alternative embodiment of the present invention, pressurized air may be supplied by way of the primary injection pipes 46 into the primary filtration treatment material to thereby clean up the primary treatment material (rock) in the trench 45.

With reference to FIGS. 2, 3 and 6, wastewater enters a chamber 14 with a manhole access, through collector mains 16, the volume of the wastewater preferably being measured as it enters the chamber 14. The wastewater flow from the collector mains 16 is combined, and thereafter travels (as illustrated by the arrow 19 in FIG. 3) within a large collector main 18, for example, beneath the ground, or as illustrated in the embodiment of FIG. 2, beneath a road surface 20, and thereafter empties into a first compartment 22 of a settling chamber 23. The wastewater 5 thereafter flows through passage pipes 24 or passageways into a second compartment 26 within the settling chamber 23. The settling chamber 23 provides wastewater treatment, by providing retention time, and by protecting the distribution box 28 (further described herein) from receiving turbulent flows of wastewater. In one embodiment of the present invention, it may also be adapted to provide aeration in a manner known to a person skilled in the art, and/or to provide an insertion point for chemicals in a manner known to a person skilled in the art, and/or for providing a pump or other device for pumping wastewater into the disposal field. In one embodiment of the present invention, baffles (not shown) may be positioned within the settling chamber 23 to collect and store floating matter which may be present in the wastewater flow.

As wastewater enters the first compartment 22 of the settling chamber 23, it displaces an equal volume of existing wastewater from the first compartment 22 of the settling chamber 23 into the second compartment 26 of the settling chamber 23, which in turn displaces an equal volume of existing wastewater from the second compartment 26 of the settling chamber 23, into the distribution box 28 by way of a connection pipe 31. In normal operation, the distribution box 28 provides further retention time for the wastewater, and additionally, as illustrated in FIG. 6, delivers an equal flow of wastewater to each disposal trench through the perforated pipes 30 which are connected to the distribution box 28 (which perforated pipes 30 may in one embodiment of the present invention, extend a short distance 29 into the distribution box 28) and adapted to receive wastewater therefrom for delivery to the disposal trench 32 as more fully described herein. Wastewater flows into, and along the perforated pipes 30 from which it is released (by way of the perforations therein), preferably, rather evenly, into the disposal trenches 32 in which the perforated pipes 30 have been installed.

As illustrated in FIGS. 8A and 8B, an alternative embodiment of the present invention is provided, a field top 84 (preferably made of Class A stone) being provided and adapted to shed surface water. In this embodiment of the present invention, topsoil and vegetation 86 positioned remotely from the trench 45 (or in an alternative embodiment of the present invention, trenches) is used to promote evapotranspiration and thereby assisting in the wastewater treatment process. In this embodiment of the invention, wastewater flows to and through the distribution box 28 as previously described herein, and into the perforated pipe 30, from which it passes into the chamber 44, and thereafter the primary filtration treatment material 43 (preferably rock or other material known to a person skilled in the art, having a flow rate of preferably 4-12), a strong, durable and water permeable geo-textile fabric 47 surrounding and containing the primary filtration treatment material 43 and the storage material 49 (which is preferably large rocks with lots voids or fillable space therebetween) positioned therebeneath as illustrated in FIG. 8. The water thereafter may enter the gravel 54 which acts as a secondary treatment material, provides partially treated wastewater storage capacity, and by permitting the partially treated wastewater to flow therethrough, delivers partially treated wastewater to the topsoil and vegetation 86, and allows for high levels of aerobic bacteria action on the partially treated wastewater (it being understood that the selection, quantity, and placement of the gravel 54 and the vegetation 86 should reflect a balance between maximizing evapotranspiration potential and minimizing the breakout risk of insufficiently treated wastewater). In this embodiment of the invention, a secondary top 80 is also provided (preferably made of fine particulate material of a type known to a person skilled in the art). In this embodiment of the invention, the secondary top 80 aids in the dispersion of surface water and provides for an efficient placement of the top 84 (preferably made of Class-A stone).

In a further alternative embodiment of the present invention, a water barrier may also be positioned inside a field to direct wastewater flow for a variety of purposes, such as, for example, forced evapotranspiration and for other purposes as would be known to person skilled in the art.

While the present invention has been described with reference to perforated pipes, as would be known to a person skilled in the art, various alternative products are available as substitutes for perforated piping, which alternative products are also understood to be within the scope of the present invention.

The present invention has been described herein with regard to preferred embodiments. However, it will be obvious to persons skilled in the art that a number of variations and modifications can be made without departing from the scope of the invention as described herein.

What is claimed is:

1. A method for treating wastewater, the method comprising the steps of:
a. distributing the wastewater into a disposal trench;
b. percolating the wastewater through primary filtration treatment material positioned within the trench;
c. transferring the wastewater into a storage area filled with storage material;
d. percolating the wastewater through secondary treatment material;
e. transferring the wastewater away from the secondary treatment material and into the environment;
wherein the secondary treatment material is positioned at a distance horizontally from the trench.

2. A method for treating wastewater as defined in claim 1 comprising the step of injecting one of dosing chemicals, water under pressure, and air under pressure into the filtration material.

3. A method for treating wastewater as defined in claim 1 wherein step e. comprises transferring the wastewater through a layer of gravel and a purpose-constructed wetland.

4. A method for treating wastewater as defined in claim 1 wherein step d. comprises restricting the percolation of the wastewater to increase an amount of water retained for storage within the storage material.

5. A device for treating wastewater, comprising:
a. at least one disposal trench adapted to receive, transport and percolate wastewater therefrom;
b. primary filtration treatment material positioned within the trench and adapted to receive and percolate wastewater therethrough;
c. a storage area filled with storage material adapted to receive and store wastewater;
d. secondary treatment material positioned at a distance horizontally from the trench adapted to receive and percolate wastewater therethrough;
e. means for transferring the wastewater away from the secondary treatment material and into the environment.

6. A device for treating wastewater as defined in claim 5 wherein the at least one disposal trench comprises a perforated pipe for transporting and distributing the wastewater, the perforated pipe being supported and secured in a height adjustable fashion.

7. A device for treating wastewater as defined in claim 5 comprising a water permeable geo-textile fabric disposed between the primary filtration treatment material and the storage material.

8. A device for treating wastewater as defined in claim 5 comprising primary injection pipes disposed within the primary filtration treatment material, the primary injection pipes for injecting one of dosing chemicals, water under pressure, and air under pressure into the filtration material.

9. A device for treating wastewater as defined in claim 5 wherein e. comprises a layer of gravel and a purpose-constructed wetland.

10. A device for treating wastewater as defined in claim 9 comprising an impervious-to-water flow block for forcing the treated wastewater through the purpose-constructed wetland.

11. A device for treating wastewater as defined in claim 5 comprising a top layer disposed on the storage material and the secondary treatment material, the top layer for shedding a substantial portion of surface water.

12. A device for treating wastewater as defined in claim 11 comprising a geo-textile fabric disposed between the top layer and the storage material and the secondary treatment material.

13. A device for treating wastewater as defined in claim 5 comprising a semi-impervious flow restricter disposed within the secondary treatment material.

14. A device for treating wastewater as defined in claim 6 comprising a distribution box for delivering an equal flow of wastewater to the perforated pipe of each disposal trench.

15. A device for treating wastewater as defined in claim 5 wherein the secondary treatment material comprises a layer of gravel covered by a layer of topsoil and vegetation, the secondary treatment material being disposed such that an evapotranspiration potential is substantially maximized while a breakout risk of insufficiently treated wastewater is substantially minimized.
